(19) United States
(12) Patent Application Publication
(10) Pub. No.: US 2001/0004833 A1
(43) Pub. Date: Jun. 28, 2001

(54) Master cylinder with improved emergency braking properties for a hydraulic vehicle brake system

(76) Inventors: Peter Schluter, Kammerforst (DE); Josef Pickenhahn, Mending (DE)

Correspondence Address: MacMillan, Sobanski & Todd, One Maritime Plaza, 4th Floor, 720 Water Street, Toledo, OH, 43604, US

(21) Appl. No.: 09/767,414

(22) Filed: Jan. 23, 2001

Related U.S. Application Data
(63) Continuation of application No. PCT/EP99/05174, filed on Jul. 20, 1999.

(30) Foreign Application Priority Data
Jul. 29, 1998 (DE) 198 34 193.8

(51) Int. Cl. F15B 7/00

(52) U.S. Cl. 60/533

(57) ABSTRACT

A master cylinder (10) for a hydraulic vehicle brake system has a housing (34) and a bore (36) which is disposed therein and in which a hollow cylindrical primary piston (38), which acts on a pressure chamber (40), is guided in a sealing and axially displaceable manner. An axially displaceable, hollow cylindrical auxiliary piston (42) is accommodated in the primary piston (38), into which piston (42) an actuating piston (46) projects, which piston (46) is adapted to be actuated by means of an input member (24), is is guided in a sealing and displaceable manner in the auxiliary piston (42) and is resiliently preloaded away from the latter at least during braking. The actuating piston (46) has a first hydraulically active diameter (D₁) and the auxiliary piston (42) has a second hydraulically active diameter (D₂). The auxiliary piston (42) is rigidly coupled to the actuating piston (46) after covering a determined distance against its resilient preload. In order to achieve a brake assistant function, a shift piston (58) is disposed in the primary piston (38), which shift piston is resiliently preloaded in the direction of the pressure chamber (40) and is adapted to be displaced axially relative to the auxiliary piston (42). The resilient preload of the shift piston (58) corresponds to a predetermined pressure level in the pressure chamber (40), and the shift piston (58) is displaced relative to the auxiliary piston (42) against the spring preload once this pressure level has been exceeded, whereby a valve (68) closes the fluid connection between the second hydraulically active diameter (D₂) of the auxiliary piston (42) and the pressure chamber (40).

The present invention relates to a master cylinder for a hydraulic vehicle brake system according to the precharacterising clause of claim 1. A master cylinder of this kind is known, for example, from DE 44 29 439 C2.

The reaction to the input member of master cylinders of the assumed type takes place purely hydraulically, i.e. there is no so-called reaction disc of an elastomer material between the input member, which is usually connected to a brake pedal, and the master cylinder. A rubber-elastic reaction disc of this kind is found in by far the majority of brake booster/master cylinder units used today. This reaction disc, interacting with a so-called sensing disc, determines the “entry” behaviour of the braking force generator, i.e. ultimately the response characteristic of the brake system. Different philosophies prevail in this respect, depending on the vehicle manufacturer, with some vehicle manufacturers preferring, for example, a brake system which responds relatively strongly even to small actuating forces, while others would like to see a less “fierce” response on the part of the brake system.

Braking force generators without an interposed rubber-elastic reaction disc are frequently unsatisfactory in terms of pedal feel, for they make this seem very stiff, so that the proportionality of the vehicle brake is felt to be poor. DE 44 29 439 C2 has therefore proposed constructing the master cylinder such that a first hydraulic diameter is hydraulically active in an initial braking phase and a second diameter which is greater than the first diameter is hydraulically active subsequently. An increased brake pressure is rapidly built up at the beginning of a braking action with a relatively small actuating force by means of the first, smaller hydraulic diameter, while the second hydraulic diameter subsequently coming into action gives the driver good feedback with regard to the higher brake pressures which have meanwhile been reached.

So-called brake assistants are also known. This term usually implies a system which, when emergency braking is carried out, can provide the driver with increased braking power at substantially the same actuating force. Systems of this kind were developed because tests revealed that the majority of vehicle users do not tread on the brake pedal when emergency braking as strongly as would be necessary to achieve maximum braking power. The stopping distance of the vehicle is therefore longer than necessary. Systems of this kind already in production use a brake booster which can be electromagnetically actuated in conjunction with a device which can establish the actuating speed of the brake pedal. If this device detects an actuating speed lying above a predetermined threshold value, it is assumed that an emergency braking situation exists and the brake booster is fully driven by means of the electromagnetic actuating device, i.e. it provides its maximum boost power.

However brake boosters with an electromagnetic actuation facility are too expensive for motor vehicles of the lower and middle price category. Solutions which achieve a brake assistant function at less expense are therefore required.

Starting out from a master cylinder of the type initially mentioned, the object of the invention is to achieve a brake assistant function using simple means, i.e. in particular without a brake booster adapted to be be electromagnetically actuated. The solution to be presented should also prevent the brake assistant function from being initiated unintentionally, as far as this is possible.

This object is achieved according to the invention with a master cylinder for a hydraulic vehicle brake system having the features presented in claim 1. According to the invention, a shift piston is disposed in the hollow cylindrical primary piston of the master cylinder in addition to the auxiliary piston and the actuating piston, which shift piston is resiliently preloaded in the direction of the primary pressure chamber and can be displaced axially relative to the auxiliary piston. If a predetermined pressure level is reached in the primary pressure chamber, the shift piston is displaced relative to the auxiliary piston against the resilient preload, whereby a valve closes the fluid connection between the second hydraulically active diameter, determined by the auxiliary piston, and the pressure chamber.

According to the invention, the level of the resilient preload of the shift piston therefore determines a brake pressure level below which the brake assistant function determined by the closure of the valve cannot occur. The desired brake assistant function can only have an effect after the pressure threshold predetermined by the resilient preload of the shift piston has been exceeded. This prevents the brake assistant function from being initiated when braking in the relatively low brake pressure range, in which the majority of all braking actions occur, even if the actuating speed of the brake pedal is high.

According to preferred embodiments of the master cylinder according to the invention, the resilient preload of the shift piston is supported at the primary piston, for example at an inner projection of the primary piston.

In order to achieve a compact construction, in preferred embodiments of the master cylinder according to the invention the auxiliary piston is guided in a sealing and displaceable manner in the shift piston.

According to a first solution of the invention, the portion of the primary piston which is disposed in the direction of the actuating member is completely blocked off from the primary pressure chamber of the master cylinder by closing the above-mentioned valve. In this solution the valve is preferably constituted by an annular flange of the shift piston and a stepped contraction, co-operating with this annular flange, of the through-opening of the primary piston. The shift piston may in this case be substantially pot-shaped, such that the auxiliary piston enters the shift piston and the annular flange of the valve is disposed radially outside at the shift piston. In order that hydraulic fluid displaced by the auxiliary piston may pass into the primary pressure chamber when the valve is open, radial ducts are provided in the circumferential wall of a shift piston designed in this manner.

If, as described above, the actual shift piston is a part of the valve, the opening stroke of the valve may be limited by a circlip which is accommodated in the bore of the primary piston and against which the shift piston strikes.

The brake assistant function of the first solution according to the invention is based on the fact that a control valve, once opened, of a vacuum brake booster coupled to the master cylinder cannot re-close until a counter-force corresponding to the actuating force has been built up in the primary pressure chamber of the master cylinder. If a corresponding reaction of the primary chamber pressure to the actuating member and thus to the control valve of the brake booster is prevented, the latter —provided that the actuating force is at least constant— is driven up to its maximum booster power, which results in a perceptible increase in the brake pressure and thus the braking power which can be achieved when the actuating force is constant.

According to a second solution of the invention, the valve is constituted by a sealing cone, which is formed at the actuating piston, and a valve seat co-operating with the latter and resiliently preloaded in the direction of the sealing cone and a stop, which is disposed between the sealing cone and the valve seat and formed at the shift piston. In this solution the valve blocks off the second hydraulically active diameter, determined by the auxiliary piston, from the primary pressure chamber and, once the determined pressure threshold has been exceeded, a third hydraulically active diameter, which is smaller than the second hydraulically active diameter, comes into operation. The stop formed at the shift piston prevents the valve from closing as long as no displacement of the shift piston relative to the auxiliary piston has occurred, i.e. below the pressure threshold determining the initiation of the brake assistant function.

According to a preferred embodiment, the valve seat is formed at a hollow cylindrical valve piston, which provides the third hydraulically active diameter. The valve piston may in this case be accommodated in a sealing and displaceable manner in a pot-shaped holding element, which in turn is guided in a sealing and displaceable manner in the shift piston and comprises a constantly open passage to the primary pressure chamber. There is thus a fluid connection between the primary pressure chamber and the second hydraulically active diameter, which is determined by the auxiliary piston, when the valve is open. However the third hydraulically active diameter, which is smaller than the second hydraulically active diameter, acts on the primary pressure chamber when the valve is closed. A greater transmission of force therefore becomes effective after closing the valve, i.e. after the determined pressure level has been exceeded, which results in correspondingly higher brake pressures with the same actuating force (brake assistant function).

Two preferred embodiments of a master cylinder according to the invention are described in detail in the following on the basis of the accompanying, diagrammatic figures, in which:

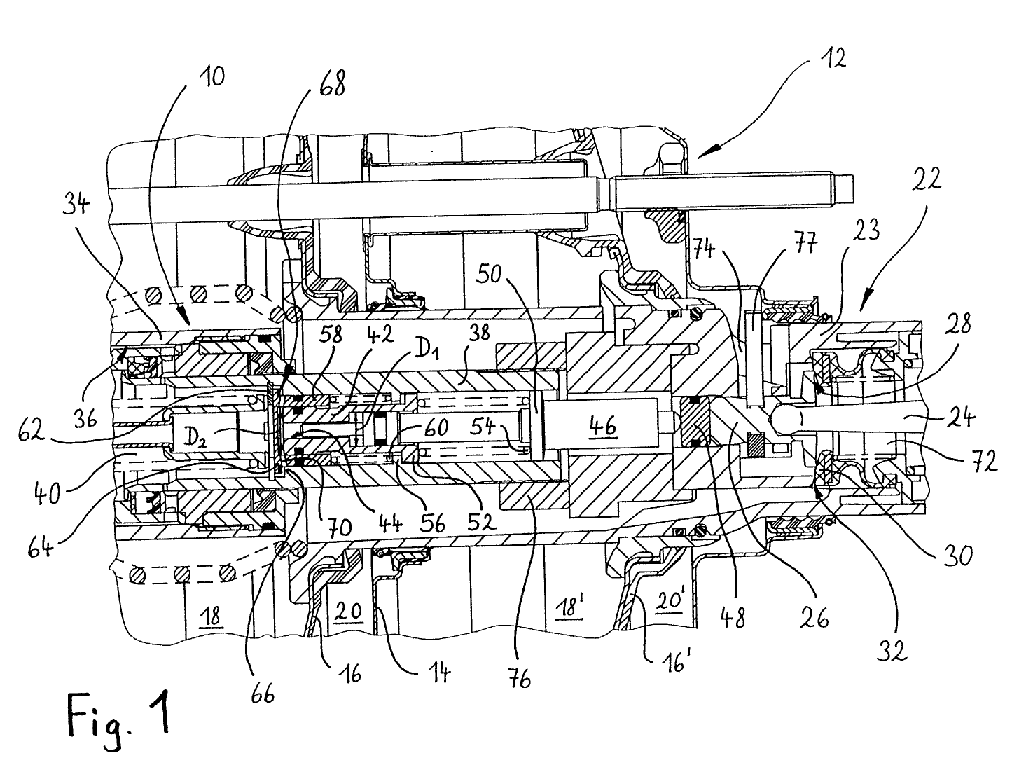

FIG. 1 is a longitudinal section through the area of interest of a first embodiment of a master cylinder according to the invention, which is connected to a vacuum brake booster, in the rest position,

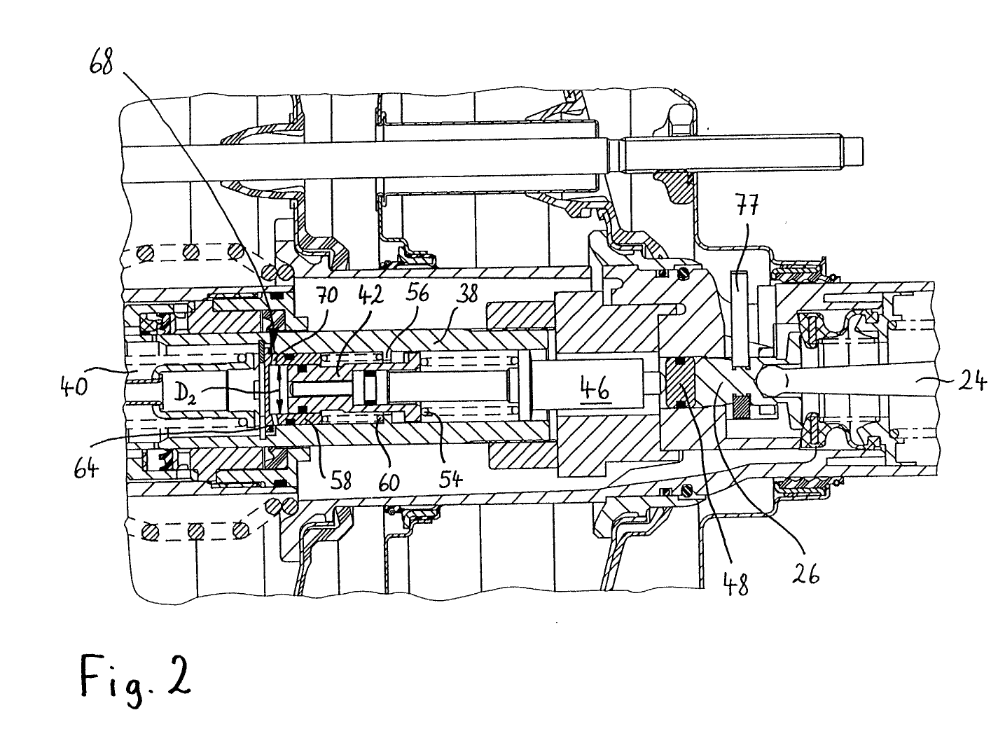

FIG. 2 is the view according to FIG. 1 in a first actuating position,

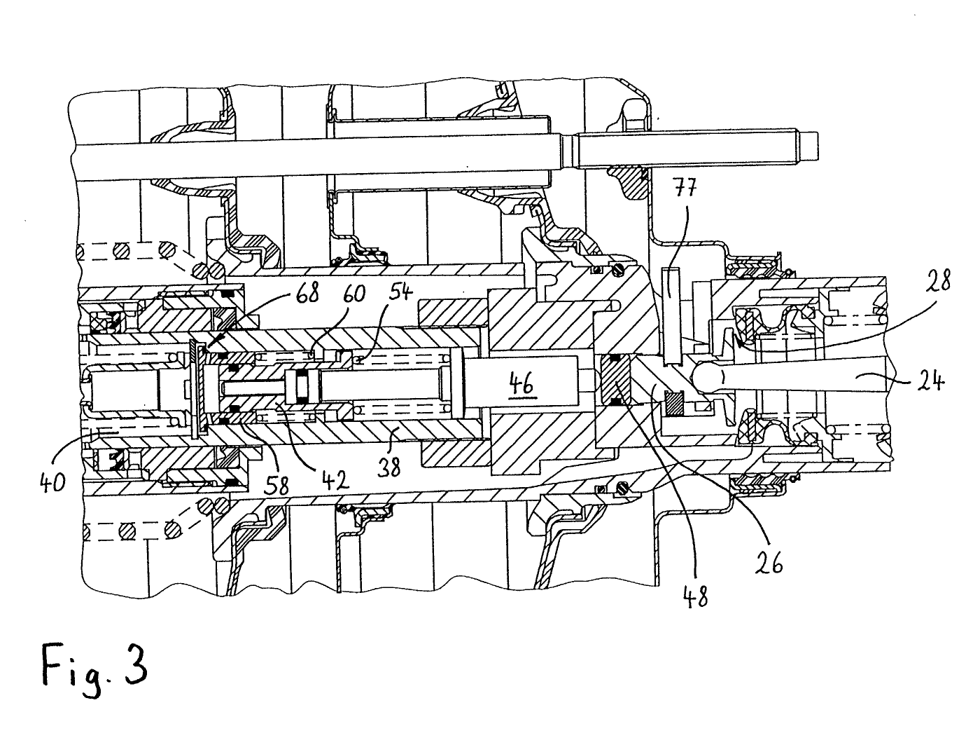

FIG. 3 is the view according to FIG. 1 in a second actuating position,

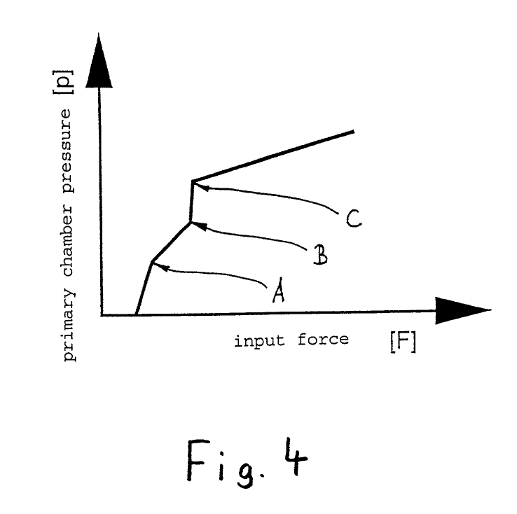

FIG. 4 is a graph presenting the interrelationship between an applied input force and the primary chamber pressure obtained as a result according to the different actuating positions for the first embodiment,

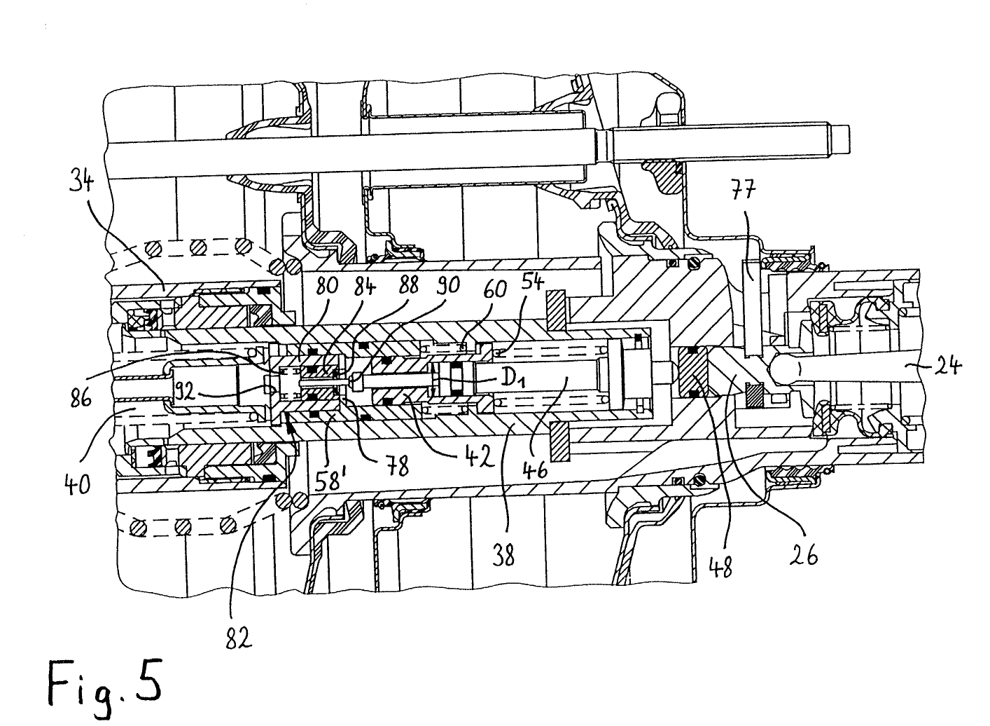

FIG. 5 is a view corresponding to FIG. 1 of a second embodiment of a master cylinder according to the invention in the rest position,

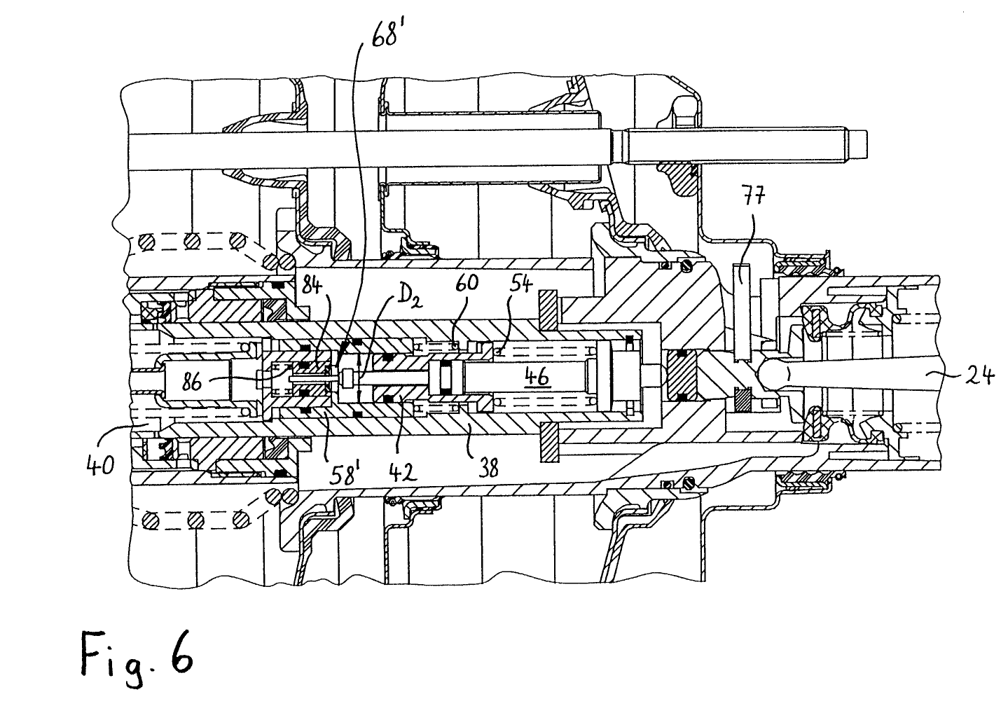

FIG. 6 is the view according to FIG. 5 in a first actuating position,

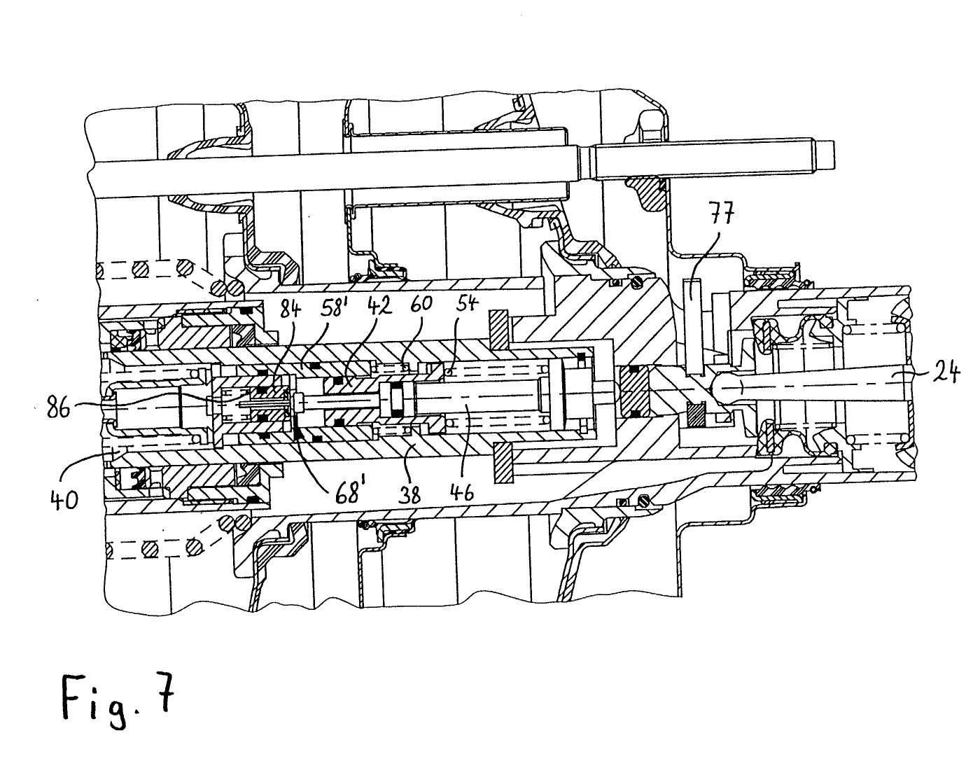

FIG. 7 is the view according to FIG. 5 in a second actuating position,

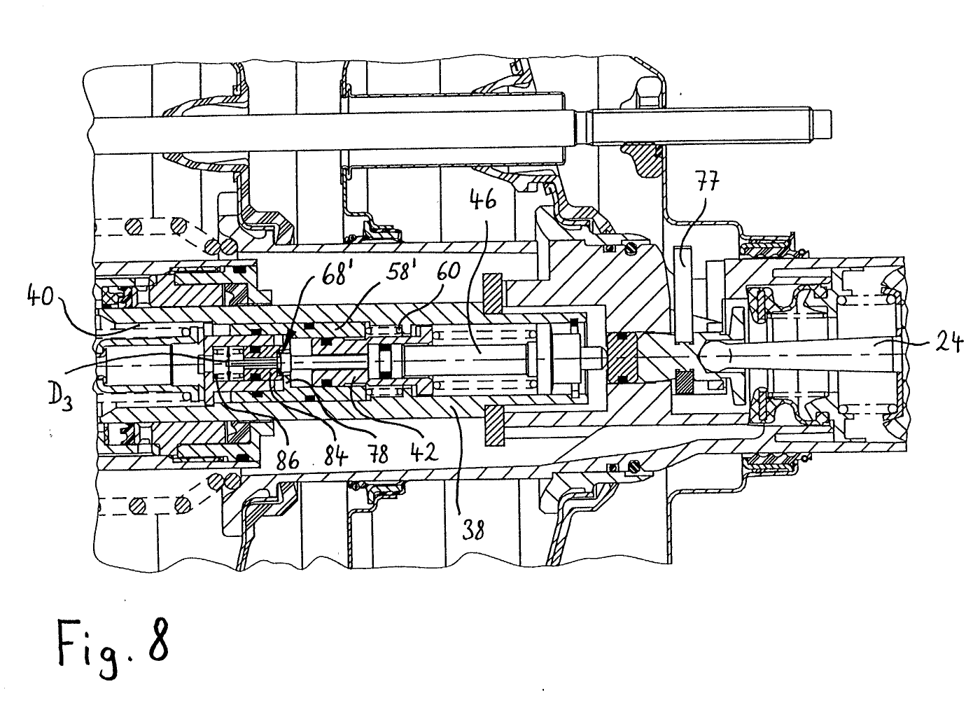

FIG. 8 is the view according to FIG. 5 in a third actuating position,

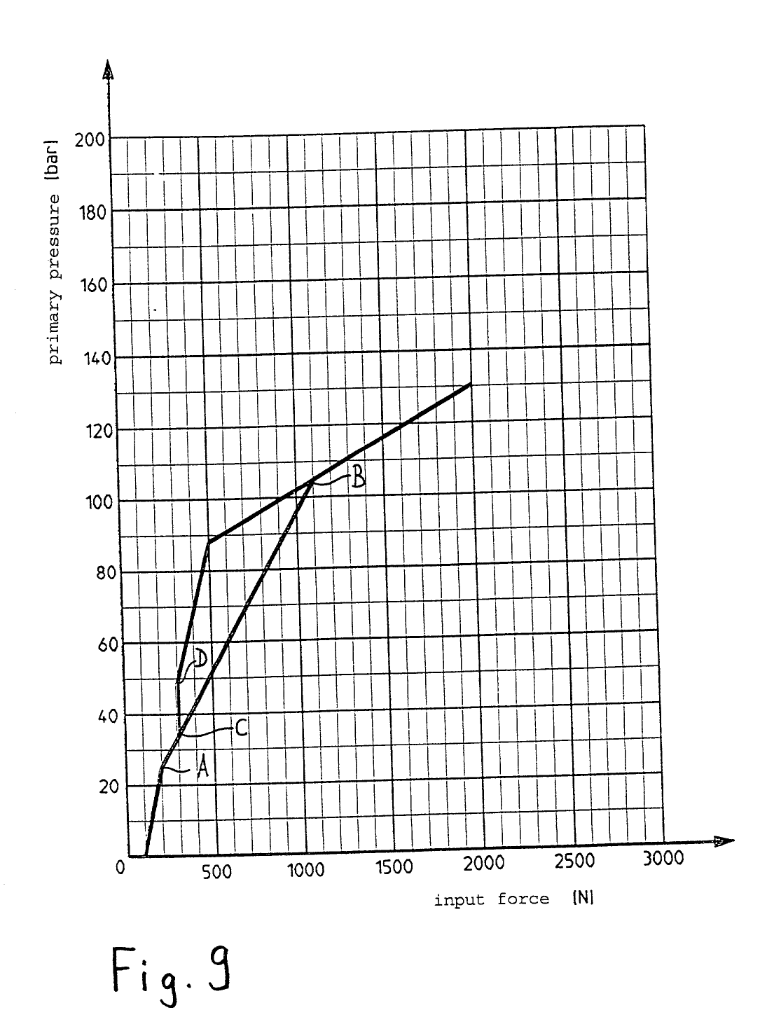

FIG. 9 is a graph presenting the interrelationship between an applied input force and the primary chamber pressure obtained as a result according to the different actuating positions for the second embodiment.

FIG. 1 represents the area of interest in connection with the invention of a first embodiment of a master cylinder 10 for a hydraulic vehicle brake system, upstream of which a vacuum brake booster 12 is connected.

The brake booster 12 has a housing, the interior of which is divided into two portions by a stationary wall 14. In one portion a mobile wall 16 separates a vacuum chamber 18 from a working chamber 20, while in the other portion a further mobile wall 16′ separates a vacuum chamber 18′ from a working chamber 20′.

During operation of the brake booster 12 the vacuum chambers 18, 18′ are constantly connected to a vacuum source, for example to the inlet duct of an internal combustion engine or to a vacuum pump. A control valve 22 is provided either to establish a connection between the working chambers 20, 20′ and the vacuum chambers 18, 18′, so that the working chambers 20, 20′ are also evacuated, or to establish a connection between the evacuated working chambers 20, 20′ and the ambient atmosphere, i.e. the ambient pressure. The represented construction of the brake booster with two vacuum chambers 18, 18′ and two working chambers 20, 20′ is called a tandem construction. However vacuum brake boosters often have just one vacuum chamber and one working chamber.

The master cylinder 10 and the brake booster 12 are actuated by means of a rod-shaped input member 24 projecting into a housing 23 of the control valve 22. The input member 24 is secured with its spherical end in a transmission piston 26, at which a first annular valve seat 28 of the control valve 22 is formed, which seat, in cooperation with a valve sealing member 30 resiliently preloaded against the first valve seat 28, can control the connection between the ambient atmosphere and the working chambers 20, 20′ of the brake booster 12. A second annular valve seat 32 of the control valve 22 is formed radially outside of and concentrically with the first valve seat 28 inside the control valve housing 22, which seat 32 also cooperates with the resiliently preloaded valve sealing member 30 and can control the connection between the vacuum chambers 18, 18′ and the working chambers 20, 20′.

The master cylinder 10 connected downstream of the brake booster 12 has a housing 34 with a bore 36, in which a hollow cylindrical primary piston 38 is guided in a sealing and axially displaceable manner. The primary piston 38 acts on a pressure chamber 40, which is also called primary pressure chamber and is axially bounded in the bore 36 of the master cylinder housing 34 between the primary piston 38 and a secondary piston which is not shown and is disposed in floating fashion in the bore 36. The pressure chamber 40 is connected to a brake circuit of the vehicle brake system when the master cylinder 10 is fitted.

An auxiliary piston 42 with a stepped through-bore 44 is accommodated in the primary piston 38, in which bore an end, stepped in a complementary fashion, of an actuating piston 48 is guided in a sealing and displaceable manner, the end defining a first hydraulically active diameter D₁. The other end of the actuating piston 46 projects out of the primary piston 38 in the direction of the input member 24. Each displacement of the input member 24 in the actuating direction, i.e. to the left in FIG. 1, is transmitted via a sealing piston 48 guided in the control valve housing 23 to the actuating piston 46 of the master cylinder 10.

A compression spring 54 disposed in the primary piston 38 and supported at an annular collar 50 of the actuating piston 46 and at a collar 52 of the auxiliary piston 42 forces the actuating piston 46 and the auxiliary piston 42 apart and pushes the auxiliary piston 42 against a stop 56 of the primary piston 38 and the actuating piston 46 against the sealing piston 48.

In the first embodiment represented in FIGS. 1 to 3 the auxiliary piston 42 is guided in a sealing and displaceable manner in an approximately pot-shaped shift piston 58, which in turn is guided in a sealing and displaceable manner in the bore 36 of the primary piston 38. The shift piston 58 is preloaded in the direction of the pressure chamber 40 by a compression spring 60, which is supported at the stop 56, and is axially supported at a circlip 62, which is accommodated in the bore 36 of the primary piston 38. In the radially outward direction the shift piston 58 comprises at its head an annular flange 64 of an enlarged diameter which can co-operate with a stepped contraction 66 of the bore 36 of the primary piston 38. The annular flange 64 is provided with elastomer material on the side which is turned towards the contraction 66. This measure creates a valve 68, which is represented in the open position in FIG. 1 and closes as a result of the annular flange 64 coming to lie against the stepped contraction 66 when the force acting on the head of the shift piston 58 on account of the hydraulic pressure in the pressure chamber 40 is greater than the force of the compression spring 60 acting in the opposite direction. The compression spring 60 therefore defines a pressure threshold above which the valve 68 closes.

The operation of the embodiment according to FIGS. 1 to 3 is now explained in detail. Actuation of the brake booster 12 or the master cylinder 10 displaces the input member 24 into the brake booster 12, i.e. to the left in the figures. This displacement is instantaneously transmitted via the transmission piston 26 and the sealing piston 48 to the actuating piston 46. The actuating piston 46 displaces hydraulic fluid with its hydraulically active diameter D₁ through the stepped through-bore 44 of the auxiliary piston 42 into the shift piston 48, out of which the hydraulic fluid flows through radial ducts 70 and then through the open valve 68 into the pressure chamber 40, where it raises the pressure accordingly.

The above-mentioned displacement of the input member 24 also causes the first valve seat 28 formed at the transmission piston 26 to be lifted off the valve sealing member 30, whereby ambient air can pass through a duct 72 surrounding the input member 24 and past the open valve seat 28 through a further duct 74 formed in the control valve housing 23 into the working chamber 20′ and from the latter into the other working chamber 20. This produces a pressure difference at the mobile walls 16 and 16′, and the resulting force tends to displace the mobile walls 16 and 161 to the left. This force is transmitted from the mobile walls 16 and 16′ to the control valve housing 23 which delivers the force to the primary piston 38 via an adjusting ring 76. The primary piston 38 is consequently displaced into the pressure chamber 40, resulting in a corresponding increase in the hydraulic pressure in the pressure chamber 40.

As from a certain, first pressure value in the pressure chamber 40 which is predetermined by the compression spring 54, the force acting from the pressure chamber 40 on the auxiliary piston 42 is greater than the force of the compression spring 54 acting in the opposite direction. The auxiliary piston 42 is as a result displaced axially against the force of the compression spring 54 and relative to the actuating piston 46 until the stepped contraction in the through-bore 44 of the auxiliary piston 42 strikes against the portion of the actuating piston 46 which determines the first hydraulically active diameter D₁ and is guided in a sealing and displaceable manner in the auxiliary piston 42 (see FIG. 2). As from this instant, the actuating piston 46 and the auxiliary piston 42 form a unit and it is no longer the first hydraulically active diameter D₁ of the actuating piston 46 which is effective as the actuating piston 46 is displaced further in the actuating direction, but rather a larger second hydraulically active diameter D₂, which is determined by the auxiliary piston 42. The smaller first hydraulic diameter is D₁ is therefore active in an initial braking phase, which causes the brake pressure in the pressure chamber 40 to rise more rapidly in relation to the actuating force, while the larger second hydraulic diameter D₂ is effective after the actuating piston 46 has been coupled to the auxiliary piston 42, resulting in a better feedback of the brake pressure in the pressure chamber 40 to the input member 24 and thus to the brake pedal; DE 44 29 439 C2 is to be referred to in detail in this respect.

If the actuating force applied to the input member 24 is not increased, the valve sealing member 30 again comes into contact with the first valve seat 28 during the displacement of the control valve housing 23, so that the supply of air to the working chambers 20 and 20′ is interrupted (position of equilibrium, both valve seats 28 and 32 closed, see FIG. 2).

As from a certain, second pressure value in the pressure chamber 40, which is predetermined by the compression spring 60, the resulting force on the shift piston 58 exceeds the force of the compression spring 60 acting on it in the opposite direction, leading to a displacement of the shift piston 58 against the force of the compression spring 60 and consequently in the annular flange 64 coming to lie against the contraction 66 of the bore 36 of the primary piston 38. The valve 68 is thus closed (see FIG. 3).

If the first valve seat 28 of the control valve 22 is still open at the instant when the valve 68 closes (see FIG. 3), which occurs when the input member 24 is actuated with a rapid and relatively large stroke, and if, in addition, the actuating force exerted on the input member 24 is not cancelled, the so-called brake assistant function then becomes effective, as—given a constant actuating force—n an open first valve seat 28 could now only be closed by a corresponding counter-pressure of the master cylinder 10 resulting from the pressure in the pressure chamber 40. However there is no longer any possibility of the brake pressure in the pressure chamber 40 reacting to the transmission piston 26 and the first valve seat 28 formed at the latter when the valve 68 is closed, for the fluid connection between the pressure chamber 40 and the components disposed to the right of the shift piston 58 in the figures, in particular to the actuating piston 46, is interrupted. The first valve seat 28 therefore remains open and ambient air continues to flow into the working chambers 20 and 20′ until the maximum possible differential pressure and thus the maximum possible boost force of the brake booster 12 is reached (run-out point of brake booster).

As described previously, the boost force of the brake booster 12, which increases up to the run-out point, is transmitted via the control valve housing 23 to the primary piston 38, so that the pressure in the pressure chamber 40 rises accordingly. However the reaction force perceptible at the brake pedal does not rise, but rather remains at a level corresponding to the second predetermined pressure value. After the run-out point of the brake booster 12 has been reached, a locking bar 77, which is secured to the transmission piston 26 and projects into the duct 74, lies against the control valve housing 23, so that the pressure in the pressure chamber 40 can only be increased by increasing the actuating force exerted on the input member 24 according to the transmission determined by the hydraulically active diameter of the primary piston 38, although without any additional boost by the brake booster 12.

FIG. 4 shows the described interrelationships in the form of a graph. The point A represents the change-over from the first hydraulically active diameter D₁ to the larger second hydraulically active diameter D₂ in the course of normal braking, while the point B represents the closure of the valve 68 in the course of panic braking (emergency braking), which occurs upon actuating the brake pedal quickly and with a relatively large stroke. As from the point B, with the input or actuating force constant, the booster force is increased up to the run-out point C of the brake booster 12 (brake assistant function). As from the run-out point C, an increase in the actuating force only has an effect according to the transmission of force determined by the hydraulically active diameter of the primary piston 38, without the brake booster 12 contributing any further force.

FIGS. 5 to 8 show a second embodiment of a master cylinder 10, which differs from the first embodiment described previously by a different configuration of the shift piston and valve, which is why these elements are marked with the reference characters 58′ and 68′. As in the case of the first embodiment, the auxiliary piston 42 is guided in a sealing and displaceable manner in the shift piston 58′ in the second embodiment, although the shift piston 58′ is a hollow cylinder with a stop 78 disposed therein. The shift piston 58′ is guided in a sealing and displaceable manner on the one hand in the primary piston 38 and on the other on a hollow cylindrical portion 80 of a substantially pot-shaped holding element 82, which extends from the pressure chamber 40 into the shift piston 58′.

The holding element 82 serves to accommodate a valve piston 84, which is guided in a sealing and displaceable manner in the hollow cylindrical portion 80 and preloaded by means of a compression spring 86 housed therein against the stop 78 in the shift piston 58′. An annular valve seat 88 is formed at the valve piston 84, which is likewise in the form of a hollow cylinder, at its end face which is turned towards the stop 78.

In the second embodiment the actuating piston 46 passes through the auxiliary piston 42 with its end disposed in the primary piston 38 and projects into the hollow cylindrical valve piston 84 with a pin-shaped end portion. A sealing cone 90, which can co-operate with the valve seat 88 and constitutes with the latter the valve 68′, is formed axially between the auxiliary piston 42 and the valve piston 84 at the actuating piston 46. The holding element 82 comprises a constantly open passage 92 in its bottom, so that there is a fluid connection between the pressure chamber 40 and the second hydraulically active diameter D₂, which is determined by the auxiliary piston 42, when the valve 68′ is open.

In the initial phase the second embodiment operates in a manner similar to that of the first embodiment, i.e. after a predetermined first pressure level in the pressure chamber 40 has been reached, the auxiliary piston 42 is at first displaced against the force of the compression spring 54 relative to the actuating piston 46 until the latter is coupled to the auxiliary piston 42, so that the second hydraulic diameter D₂ determined by the auxiliary piston 52 comes into action from this point on (see FIG. 6). As the actuating force applied to the input member 24 increases, the brake pressure achieved in the pressure chamber 40 increases in accordance with this second hydraulic effective diameter D₂ with corresponding force assistance by the brake booster 12 until the run-out point of the brake booster 12 is finally reached (see in this connection point B in FIG. 9). The brake pressure can subsequently only be increased as the input or actuating force increases according to the transmission of force determined by the effective hydraulic diameter of the primary piston 38.

Upon emergency braking, when the driver normally treads on the brake pedal at a relatively high speed and thus the input member 24 is displaced to a relatively large degree with respect to the control valve housing 23, the following is occurs in contrast to the first embodiment: The pressure difference in the brake booster 12, which increases rapidly due to the first valve seat 28 of the control valve 22 then being wide open, gives rise to a force increasing at a correspondingly high speed and delivered from the control valve housing 23 to the primary piston 38. The hydraulic pressure in the pressure chamber 40 therefore rises rapidly to a value which results in the shift piston 58′ being displaced against the force of the compression spring 60 (see FIG. 7). The stop 78, which is formed in the shift piston 58′, is displaced with the latter, so that the valve piston 84 resiliently preloaded against this stop 78 also follows this movement and approaches the sealing cone 90 (see FIG. 7).

If the initially high actuating speed is maintained, the sealing cone 90 can come to lie against the valve seat 88 and thereby close the valve 68′ (see FIG. 8). The second effective hydraulic diameter D₂ is therefore uncoupled from the pressure chamber 40 and a third hydraulic diameter D₃ determined by the valve piston 84 comes into action as the braking operation continues. The third hydraulic diameter D₃ is smaller than the second effective hydraulic diameter D₂, so that there is again an increase in the transmission of force of the master cylinder 10, i.e. a predetermined increase in input force results in a greater increase in brake pressure than before.

If the actuating piston 46 is displaced further in the actuating direction with the valve 68′ closed, the valve piston 84 separates from its stop 78 in the shift piston 58′ and forces hydraulic fluid through the passage 92 into the pressure chamber 40. These conditions are also quite obvious from FIG. 9, where the point C represents the instant at which the valve 68′ closes and at which the hydraulic pressure in the pressure chamber 40 rises due to the now reduced effective hydraulic diameter (from D₂ to D₃) with a constant input force. Each further rise in input force (as from point D in FIG. 9) is followed by a rise in pressure in the pressure chamber 40 which, because of the smaller effective diameter D₃, is greater than a pressure increase occurring during normal braking with the same rise in input force. As from the time at which the run-out point of the brake booster 12 is reached, the brake pressure can only be increased as the input or actuating force increases according to the transmission of force determined by the effective hydraulic diameter of the primary piston 38.

The valve 68′ opens again immediately if the actuating force is reduced. It is to be pointed out once again that the valve 68′ can only close if a second pressure threshold in the pressure chamber 40 predetermined by the force of the compression spring 60 has been reached or exceeded and the shift piston 58′ consequently displaced against the actuating direction. It is also impossible for the brake assistant function to be employed below this second pressure threshold in the second embodiment.

What is claimed is:

1. Master cylinder for a hydraulic vehicle brake system, comprising;
a housing and a bore disposed therein,
a hollow cylindrical primary piston, which is guided in the bore in a sealing and axially displaceable manner and acts on a pressure chamber,
a hollow cylindrical and axially displaceable auxiliary piston, which is disposed in the primary piston, and
an actuating piston, which projects into the primary piston and the auxiliary piston, can be actuated by means of an input member, is guided in a sealing and displaceable manner in the auxiliary piston and is resiliently preloaded away from the latter at least during braking, wherein the actuating piston has a first hydraulically active diameter and the auxiliary piston has a second hydraulically active diameter, and the auxiliary piston is rigidly coupled to the actuating piston after covering a determined distance against the resilient preload, wherein
a shift piston is disposed in the primary piston, which shift piston is resiliently preloaded in the direction of the pressure chamber and can be displaced axially relative to the auxiliary piston, wherein
the resilient preload of the shift piston corresponds to a predetermined pressure level in the pressure chamber, and the shift piston is displaced relative to the auxiliary piston against the spring preload if this pressure level is exceeded, whereby a valve closes the fluid connection between the second hydraulically active diameter of the auxiliary piston and the pressure chamber.

2. Master cylinder according to claim 1, wherein the resilient preload of the shift piston is supported at the primary piston.

3. Master cylinder according to claim 1 or 2, wherein the auxiliary piston is guided in a sealing and displaceable manner in the shift piston.

4. Master cylinder according to any one of claims 1 to 3, wherein the valve is constituted by an annular flange of the shift piston and a stepped contraction, co-operating with the annular flange, of the bore of the primary piston.

5. Master cylinder according to claim 4, wherein the shift piston is substantially pot-shaped and the fluid connection between the second hydraulically active diameter of the auxiliary piston and the pressure chamber when the valve is in the open position is established by radial ducts in the circumferential wall of the shift piston.

6. Master cylinder according to claim 4 or 5, wherein the opening stroke of the valve is limited by a circlip which is accommodated in the primary piston and against which the shift piston strikes.

7. Master cylinder according to any one of claims 1 to 3, wherein the valve is constituted by a sealing cone, which is formed at the actuating piston, and a valve seat co-operating with the sealing cone and resiliently preloaded in the direction of the sealing cone and a stop, which is disposed between the sealing cone and the valve seat and formed at the shift piston.

8. Master cylinder according to claim 7, wherein the valve seat is formed at a hollow cylindrical valve piston with a third hydraulically active diameter.

9. Master cylinder according to claim 8, wherein the valve piston is accommodated in a sealing and displaceable manner in a pot-shaped holding element, which in turn is guided in a sealing and displaceable manner in the shift piston and comprises a constantly open passage to the pressure chamber.

10. Braking force generator unit for a hydraulic vehicle brake system, comprising a brake booster and a master cylinder, characterised by a master cylinder according to any one of the preceding claims.
